(19) United States
(12) Patent Application Publication
(10) Pub. No.: US 2006/0133633 A1
(43) Pub. Date: Jun. 22, 2006

(54) Mobile telephone with metal sensor

(75) Inventors: Lassi Hyvonen, Helsinki (FI); Esko Jarvinen, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/015,518

(22) Filed: Dec. 17, 2004

(51) Int. Cl. H04R 25/00

(52) U.S. Cl. 381/315

(57) ABSTRACT

A mobile telephone including a hearing aid compatible system for coupling an output of the mobile telephone to a hearing aid device of a user; and a metal detector system adapted to detect a metal object brought into proximity relative to the mobile telephone.

### BACKGROUND OF THE INVENTION

1. Field of the Invention

The present invention relates to a mobile communications device and, more particularly, to a mobile communications device having a metal detector function and/or use of a coil in a mobile communications device for multiple functions.

2. Brief Description of Prior Developments

Hand held metal proximity detectors have been commercially available for years. Two well known fields of the small hand held metal proximity sensors are in security and construction safety. In construction, hand held metal proximity detectors are used for detecting electric cables inside a structure and avoid the danger of electric shock before drilling or otherwise penetrating the structure, and detecting steel reinforcement bars inside concrete structures and avoid the danger of damaging the structure for example by cutting a rebar with a drill. In security, hand held metal proximity detectors are used for example at airports to check that passengers do not carry weapons.

HAC, hearing aid compatible, is a system to interconnect the speaker of a phone magnetically into a hearing aid device. A telecoil or T-coil of the HAC system is mounted inside both the hearing aid and the audio device such as the telephone handset. It allows the signals to be coupled from the phone to the hearing aid without a wired electrical connection and it avoids the problems that microphones would have with the amplification of background noise.

The HAC-system is old, it was introduced in the 1950's. It is available in many conventional phone devices even if the majority of the people don't need it and don't know their devices are HAC-compatible. A telecoil is an induction coil. An induction coil is simply a metal rod that is encircled by many turns of a copper wire. Placed in an alternating magnetic field, an alternating electrical current is “induced” in the copper wire. (Reciprocally, an electrical current in a wire creates a tiny magnetic field around it.) What happens is that the coil converts (changes) magnetic energy to electrical energy, in much the same way that a microphone converts sounds waves to electrical energy. Generally, the strength of the inductive pick-up is determined by the number of turns of the copper wire around the metal axis rod. Larger rods permit more turns and more powerful telephone coils. Newer “T” coils include an integrated amplifier, which makes it feasible to reduce the physical size of the “T” coil and still operate effectively. Still, the smaller the hearing aid, the less room there is for a telecoil, and thus in tiny aids telecoils are either weaker or excluded entirely.

When a hearing aid is switched to the “T” position, the telecoil is set to detect only an electromagnetic field. The strength of the electrical current “induced” in the telecoil by the electromagnetic field is directly proportional to both the energy in the magnetic field and to the relative positions of the induction coil in the hearing aid to the magnetic field (in a telephone or wire loop). This latter consideration is particularly important; in some positions, little or no electrical current will be created in the induction coil. The magnetic field will simply “pass through” the coil without producing much, if any, electrical current. This is the reason why experienced hearing aid users always experiment with the positioning with unfamiliar telephones: to find the “hot spot” where the strongest signal is heard.

The potential usefulness of telecoils in hearing aids extends beyond their original purpose—that is, detecting the serendipitous electromagnetic field surrounding the earpiece of early telephones (and current “hearing aid compatible” telephones). Telecoils can be used in any setting that provides an IL (induction loop) assistive listening system. In such a system, a loop of wire around a room (or under a rug) produces an electromagnetic field instead of, or in conjunction with, amplified sound from a loudspeaker. Telecoils can also pick up the electromagnetic signals emanating from neckloops that are placed around the neck. These are plugged into the earphone jack of FM and infra-red receivers and used with small and large-area assistive listening systems. The telecoil permits hearing aid users to “inductively” couple these devices to their personal hearing aids.

In the United States of America, regulatory authorities have decided to require that a major number of all mobile phones be hearing aid compatible in a certain time frame. The FCC has issued an order in 2003 requiring digital wireless phone manufacturers to make available to carriers within three years at least two HAC-compliant handsets with a telecoil coupling for each air interface it produces. This means that very soon there will be a telecoil in most mobile telephone devices sold in the United States.

### SUMMARY OF THE INVENTION

In accordance with one aspect of the present invention, a mobile telephone is provided comprising a hearing aid compatible system for coupling an output of the mobile telephone to a hearing aid device of a user; and a metal detector system adapted to detect a metal object brought into proximity relative to the mobile telephone.

In accordance with another aspect of the present invention, a mobile telephone is provided comprising a telecoil; and a system for using the telecoil for at least two different functions.

In accordance with one method of the present invention, a method of manufacturing a telephone is provided comprising providing the telephone with a hearing aid compatible system comprising a telecoil; and coupling the telecoil to a switch for switching use of the telecoil from use as a function of the hearing aid compatible system to use as a different function of the telephone.

### BRIEF DESCRIPTION OF THE DRAWINGS

The foregoing aspects and other features of the present invention are explained in the following description, taken in connection with the accompanying drawings, wherein:

FIG. 1 is a perspective view of a mobile communications terminal incorporating features of the present invention;

FIG. 2 is a block diagram of some of the components of the terminal shown in FIG. 1;

FIG. 3 is a diagram illustrating a common component used in the HAC system and the metal detector system of the terminal shown in FIG. 1;

FIG. 4 is a schematic diagram of some of the components used in the metal detector system shown in FIGS. 2 and 3;

FIG. 5 is a diagram illustrating a common component used in a HAC system and a radio frequency identification system in a mobile communications terminal; and

FIG. 6 is a diagram illustrating a common component used in a HAC system, a radio frequency identification system, and a metal detector system having a power line differentiation system in a mobile communications terminal.

### DETAILED DESCRIPTION OF THE PREFERRED EMBODIMENTS

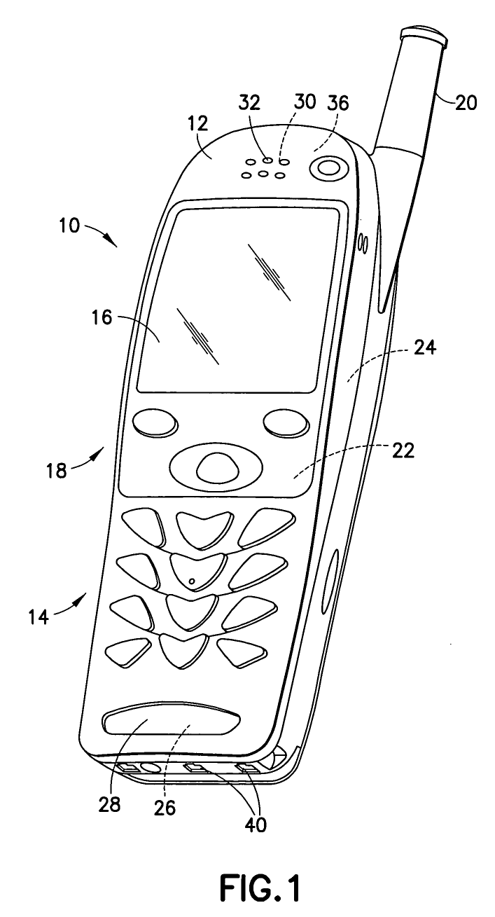

Referring to FIG. 1, there is shown a perspective view of a mobile communications terminal 10 incorporating features of the present invention. Although the present invention will be described with reference to the exemplary embodiments shown in the drawings, it should be understood that the present invention can be embodied in many alternate forms of embodiments. In addition, any suitable size, shape or type of elements or materials could be used.

In the embodiment shown, the mobile communications terminal 10 comprises a mobile telephone. However, in alternate embodiments, the mobile communications terminal could comprise any suitable type of portable hand-held communications device comprising a mobile telephone function including, for example, a hand-held communicator, a PDA, or a hand-held gaming device. Features of the present invention could also be used in any suitable type of mobile telephone. The telephone 10 generally comprises a housing 12, a keypad input section 14, a display 16, a menu/function input section 18, an antenna 20, and electronic circuitry 22 located inside the housing 12. The electronic circuitry 22 includes, for example, a printed circuit board comprising a controller 24, such as a microprocessor, a transceiver, a memory, a microphone 26 at a mouthpiece section 28, and a speaker or sound transducer 30 at an earpiece section 32. The keypad input section 14, the display 16, the menu/function input section 18, the microphone 26 and the speaker 30 generally form a user interface for the telephone. However, the telephone could comprise any suitable type of user interface including, for example, a touch sensitive screen. In addition, the telephone can comprise connectors 40 for attaching additional user interface devices to the telephone such as, for example, a headset.

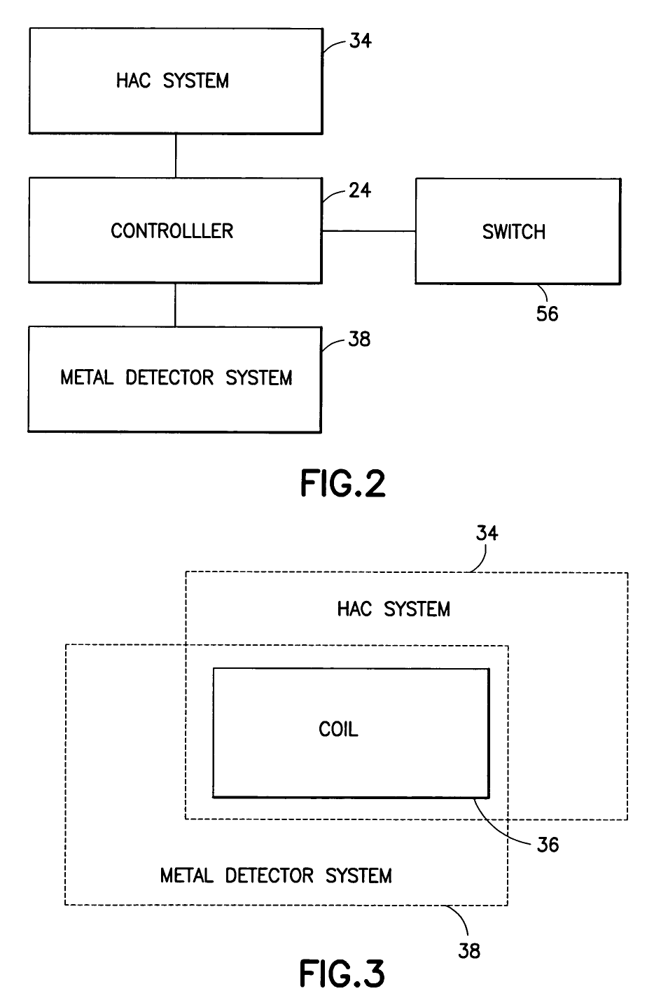

Referring also to FIG. 2, in the embodiment shown the electronic circuitry 22 of the telephone 10 comprises a hearing aid compatible (HAC) system 34 which is connected to the controller 24. The HAC system 34 comprises a telecoil or T-coil 36 (see FIG. 1). The telecoil 36 is located inside the housing 12 proximate the speaker 30 at the earpiece section 32. The telecoil 36 is adapted to communicate with another telecoil (not shown) in a hearing aid of a user to allow voice or sound signals being sent to the earpiece section to be coupled from the phone to the hearing aid without a wired electrical connection.

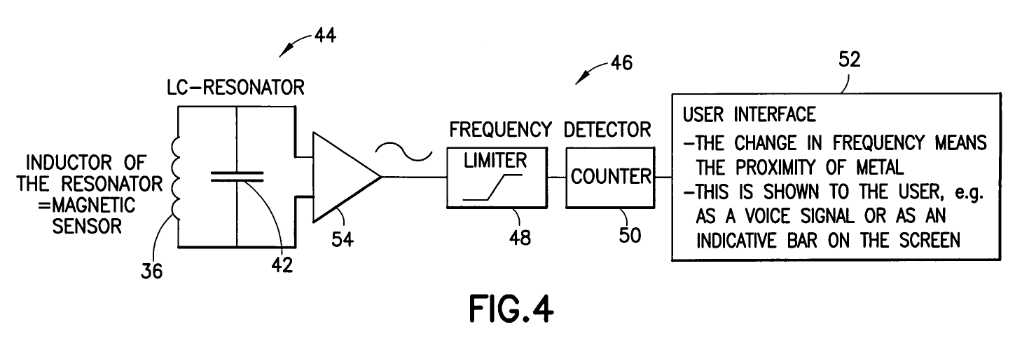

The telephone 10 also comprises a metal detector system 38. Referring also to FIG. 3, the metal detector system 38 comprises the telecoil 36. Thus, both the HAC system 34 and the metal detector system 38 comprise use of a common coil; the telecoil 36. Referring also to FIG. 4, one embodiment of the metal detector system 38 is shown. In alternate embodiments, any suitable type of circuitry or components could be used to form the metal detector system. In this embodiment, the metal detector system comprises an LC resonator 44 which comprises the coil 36 and a capacitor 42. The resonator 44 is coupled to a frequency detector 46. In this embodiment, the frequency detector comprises a limiter 48 and a counter 50. However, in alternate embodiments, any suitable type of frequency detector could be provided. The frequency detector 46 is connected to the user interface 52 of the telephone 10.

The embodiment of the invention described above utilizes the telecoil (T-coil) 36 of the HAC-system as a magnetic sensor. Within the U.S. it will be mandatory by the end of 2006 that major manufacturers of mobile handsets provide at least two handsets to carriers which are HAC compatible (hearing aid compatible). The invention introduces an economic way to integrate metal proximity sensor applications into mobile devices and bring new added value to telephone purchasers. The invention can comprise integration of a metal proximity sensor into a mobile device and utilize the integrated telecoil 36 of the mobile device as a magnetic sensor to make the implementation economic.

A simple metal detector is an LC-resonator based oscillator. The inductor of the resonator is the magnetic sensor of the metal proximity detector. The oscillator oscillates at a certain resonance frequency. When a piece of metal is brought close to the inductor, i.e. into the magnetic field of the inductor 36, eddy currents are born in the piece of metal. The eddy currents generate a magnetic field, much smaller than the main field, but opposite direction to the main field. Now, the total magnetic field is reduced by the amount of the magnetic field generated by the eddy currents. As the total magnetic field of the inductor is reduced, the inductor is seen as a smaller inductance than it was before the introduction of the piece of metal in its proximity. And further, as the inductance is now smaller, the resonant frequency of the oscillator changes to a higher frequency.

Metal detection can work on a similar principle to a HAC system, a magnetic field is induced in a circuit and when a metallic element is introduced to the magnetic field there is a change in the first magnetic field due to the creation of a second magnetic field. The magnetic field is monitored and changes can alert the user to metallic objects in close proximity. By utilizing the same coil and transmission circuitry the T-coil 36 can be adapted for use as part of a hearing aid (using the HAC system) or as part of a metal detector.

When the T-coil 36 in the handset is used for detecting metal, the coil could be excited by a suitable resonant frequency in order to produce a magnetic field. Any metal brought into close proximity would generate a second magnetic field, the change in magnetic field can be detected. A single coil implementation is possible. The coil with a capacitor makes the resonator. The resonant frequency of the resonator changes when a metal object comes into the magnetic field of the coil. The change in the resonant frequency is the signal which can be monitored.

With the present invention, the frequency can be detected. Because a typical metal detector working frequency is in the range of tens or hundreds of kilohertz, this frequency can be detected easily with the limiter 48 and the digital counter 50. The count can be read periodically and if the count in a period has increased, there is metal in proximity to the coil 36. The invention introduces an economic way to integrate metal proximity sensor applications into mobile devices. In an alternate embodiment, any suitable type of circuitry, rather than the frequency detector 46, could be connected to the coil 36 for use in determining if the coil has come into proximity with metal.

Configurations having two coils (separate RX-TX coils) are used in metal detectors and it is most probably possible to achieve better sensitivity with a two coil configuration. However, single coil configurations are used, too. The present invention does not need a second coil. However, in an alternate embodiment, a second coil could be provided. In addition, the HAC system and the metal detector system might comprise the use of non-common, separate coils. The mobile communications terminal 10 can comprise a metal detector system with or without an HAC system. The additional manufacturing overhead for the common coil embodiment described above is the associated circuitry for detecting the change in the resonant frequency; an amplifier 54, a limiter 48, a frequency counter 50. It might be even possible to find a way to use some functions of the baseband to count the frequency, since a couple of hundreds of kilohertz is a low speed in a mobile telephone device.

Audio transmission is likely to be up to approximately 20 kHz, but for metal detection the frequency to excite the coil may well be hundreds of kHz. The audio frequency is too low, typically limited below 4 kHz. Possibly a switch can be provided. For example, as shown in FIG. 2, switch 56 can be connected to the controller 24 to control whether the HAC system 34 is in use or whether the metal detector system 38 is in use. The audio filter can be switched OFF when the coil is used as metal detector, if there is an analog audio filter. If the audio filter is implemented only digitally, it can be switched OFF easily or reconfigured to another frequency. Thus, for example, the switch 56 could comprise use of programming in the telephone and the use of soft keys of the input section 18. Alternatively, the switch 56 could comprise a separate button or mechanical switch on the telephone.

The HAC system is tuned so that the phone and the hearing aid device communicate when they are in close proximity. Most probably, the devices could be tuned to communicate from a distance, but then they would capture more easily interfering noise, too. A hearing aid will work in close proximity to the handset whereas a metal detector may wish to operate at greater distances (e.g. 10 cm).

As seen in FIG. 4, the change in frequency means that the coil 36 is in proximity to metal. This can be communicated to a user at the user interface 52 such as by a sound signal at the speaker 30 and/or a visual display, such as an indicative bar, on the display screen 16. In alternate embodiments, any suitable type of use of the user interface 52 or connectors 40 to signal proximity to metal could be provided.

In one type of alternate embodiment, the telecoil 36 could be used for an alternative or additional function besides the metal detector system function. Because the metal detector system 38 is comprised in the telephone 10, the telephone 10 can be provided with suitable programming to allow automatic communication to another device via a wireless link based upon metal being sensed by the metal detector system 38. For example, the mobile communications terminal could comprise a security officer's metal detecting wand which can automatically send a signal to a remote security monitoring station when the wand detects metal. A security officer observer at the remote security monitoring station can perhaps be signaled to look to an associated video display screen to observe the security officer's further searching of the individual or package which triggered the metal detector system. As another alternative use, the security officer's metal detecting wand could automatically send a signal to the remote security monitoring station when the metal detector system detects metal and the security officer does not perform a task with the wand within a predetermined time limit after the metal has been detected. This could signal to the remote location that the security officer is having trouble after detecting metal. The task could be as simple as the security officer pressing one of the user input keys of the wand to reset the wand after metal has been detected.

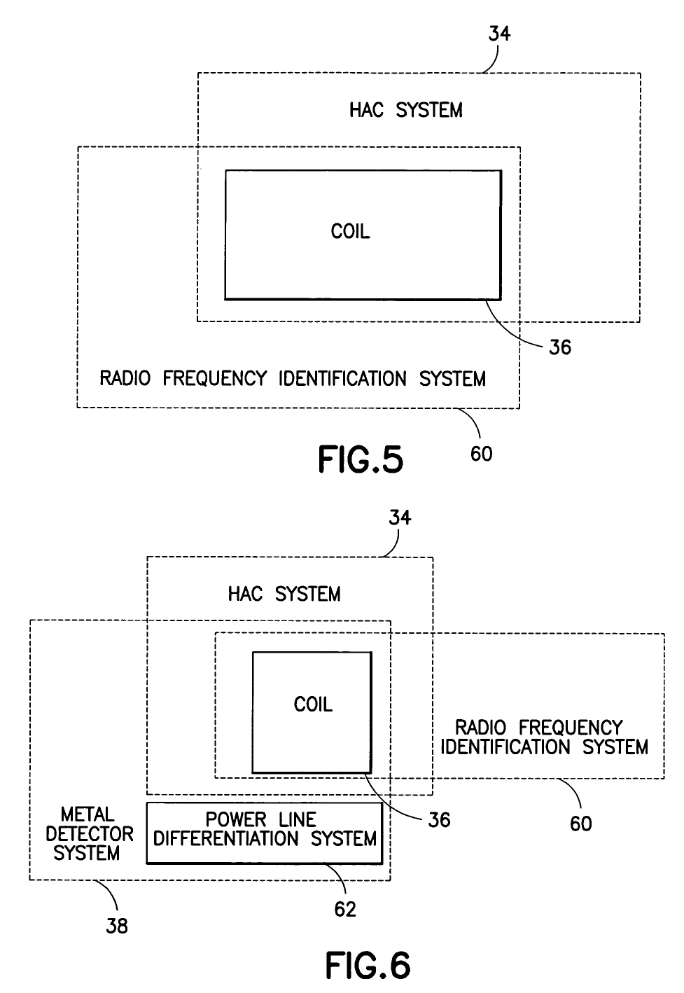

Referring to FIG. 5, in one type of embodiment the HAC coil 36 of the telephone could also be used as a radio frequency identification (RFID) coil in a radio frequency identification (RFID) system 60. Referring also to FIG. 6, it may also be desirable to allow the metal detector phone to differentiate between power cables (such as 50 Hz/60 Hz power cables) and metal in general. In the embodiment shown in FIG. 6, the phone comprises the HAC system 34 with the coil 36, the RFID system 60, and the metal detector system 38 having a power line differentiation system 62. Besides being able to detect metal, the metal detecting phone could send a different signal to the user when a power cable or power line is detected so a user does not dig into the ground or pierce through a wall where a power cable is located. This is easily implemented with the same HAC coil system, since a power line can induce a 50 Hz/60 Hz current into the coil. This 50 Hz/60 Hz signal can to be detected, such as with a counter for example. The power line detection can happen at a same time with the metal detection. Some filtering might be needed to separate the metal detection from the power line detection functions.

It should be understood that the present invention might not be limited merely to a mobile telephone. The present invention could be used in other portable electronic devices. For example, the present invention could be used in a portable audio player, such as an IPOD®, WALKMAN® or MP3 player. The present invention could be used in any portable electronic device comprising an audio speaker and adapted to work with a hearing aid (i.e., having a coil which functions similar to a telecoil).

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A portable electronic device comprising:
a hearing aid compatible (HAC) system for coupling an output of the portable electronic device to a hearing aid device of a user; and
a metal detector system adapted to detect a metal object brought into proximity relative to the portable electronic device.

2. A portable electronic device as in claim 1 wherein the hearing aid compatible system and the metal detector system comprise a common coil.

3. A portable electronic device as in claim 2 wherein the common coil comprises a telecoil.

4. A portable electronic device as in claim 3 further comprising a switch for switching use of the telecoil between use by the hearing aid compatible system and the metal detector system.

5. A portable electronic device as in claim 2 wherein the metal detector system comprises a frequency detector coupled to the coil.

6. A portable electronic device as in claim 5 further comprising a display screen and wherein the frequency detector is coupled to the display screen.

7. A portable electronic device as in claim 5 wherein the frequency detector comprises a limiter and a counter.

8. A portable electronic device as in claim 1 wherein the metal detector system comprises a single coil.

9. A portable electronic device as in claim 1 further comprising means for automatically sending a wireless signal from the portable electronic device based upon the metal detector system sensing metal.

10. A portable electronic device as in claim 1 wherein the portable electronic device comprises a mobile telephone with a transceiver.

11. A portable electronic device comprising:
a telecoil; and
a system for using the telecoil for at least two different functions.

12. A portable electronic device as in claim 11 wherein the at least two different functions comprise a hearing aid compatible system function and a metal detector system function.

13. A portable electronic device as in claim 11 wherein the system for using the telecoil comprises a switch for switching the use of the telecoil between the at least two different functions.

14. A portable electronic device as in claim 11 wherein the system for using the telecoil comprises a metal detector system adapted to detect a metal object brought into proximity relative to the portable electronic device, and wherein the metal detector system comprises a frequency detector coupled to the coil.

15. A portable electronic device as in claim 14 further comprising a display screen and wherein the frequency detector is coupled to the display screen.

16. A portable electronic device as in claim 11 wherein the system for using the telecoil for at least two different functions comprises a radio frequency identification (RFID) system comprising the telecoil, wherein the radio frequency identification (RFID) system is adapted to function as a radio frequency identifier.

17. A portable electronic device as in claim 11 wherein the system for using the telecoil for at least two different functions comprises a power line detecting system comprising the telecoil, wherein the power line detecting system is adapted to differentiate detection of a power line from a non-power line metal object.

18. A portable electronic device as in claim 11 wherein the portable electronic device comprises a mobile telephone with a transceiver.

19. A method of manufacturing a telephone comprising:
providing the telephone with a hearing aid compatible system comprising a telecoil; and
coupling the telecoil to a switch for switching use of the telecoil from use as a function of the hearing aid compatible system to use as a different function of the telephone.

20. A method as in claim 19 wherein coupling the telecoil comprises coupling the telecoil by the switch to a metal detector system for functioning as a coil in the metal detector system.

21. A method as in claim 19 further comprising coupling the telecoil to a frequency detector.

22. A method as in claim 21 further comprising coupling the frequency detector to a display screen of the telephone.

23. A method as in claim 19 further comprising providing a radio frequency identification (RFID) system comprising the telecoil.

24. A method as in claim 19 further comprising providing a power line detecting system comprising the telecoil which is adapted to differentiate detection of a power line from a non-power line metal object.
